(19) United States
(12) Patent Application Publication
(10) Pub. No.: US 2026/0236008 A1
(43) Pub. Date: Aug. 13, 2026

(54) PROGRAM EDITING ASSISTANCE DEVICE

(71) Applicant: FANUC CORPORATION, Yamanashi (JP)

(72) Inventor: Toshihiro WATANABE, Yamanashi (JP)

(73) Assignee: FANUC CORPORATION, Yamanashi (JP)

(21) Appl. No.: 19/151,300

(22) PCT Filed: Mar. 30, 2023
(86) PCT No.: PCT/JP2023/013232

§ 371 Date: Jul. 25, 2025

(51) Int. Cl. G05B 19/4155; G05B 19/402; G05B 19/409

(52) U.S. Cl. CPC G05B 19/4155; G05B 19/402; G05B 19/409

(57) ABSTRACT

The present invention provides a technology with which the degree of freedom in setting an indexing angle can be increased, within a range in which interference is avoided, in the creation of a program for controlling the operation of a machine tool. A program editing assistance device 10 comprises: an analysis unit 11 that generates, from a program, command data including at least a prescribed position of a prescribed point on a movement path of a tool 20, and a relative indexing angle between the tool 20 and a workpiece W at the prescribed position; a tool shape acquisition unit 12 that acquires shape information of one or more components which constitute the tool 20; a range calculation unit 13 that calculates, on the basis of the command data and the shape information, an indexing angle range in which the workpiece W and the tool 20 do not interfere with each other at the prescribed position; and a presentation unit 14 that outputs the indexing angle range.

### TECHNICAL FIELD

The present disclosure relates to a program editing assistance device.

### BACKGROUND ART

Conventionally, a machining method of performing lathe turning while dynamically changing an indexing angle of a tool viewed from a workpiece, in order to achieve machining of a complex shape with one lathe tool has been known. In such a type of machining, commands for the position and the indexing angle of an edge are issued to each block of a program, and a linear shaft and a rotational shaft are controlled based on these commands and a preset tool offset. For example, Patent Documents 1 to 4 disclose technologies related to such machining using the indexing angle of the above-described type.

### CITATION LIST

### Patent Document

Patent Document 1: Japanese Unexamined Patent Application, Publication No. 2002-304203
Patent Document 2: Japanese Unexamined Patent Application, Publication No. 2002-79428
Patent Document 3: Japanese Unexamined Patent Application, Publication No. 2011-83830
Patent Document 4: Japanese Unexamined Patent Application, Publication No. 2005-305579

### DISCLOSURE OF THE INVENTION

### Problems to be Solved by the Invention

In a case of creating a program, it is sometimes desired to freely set the indexing angle. In this case, according to the conventional technology, an indexing angle for avoiding interference can be determined, but it is difficult to grasp the range where interference occurs. In view of an operator or the like of the machine tool setting, by themself, the indexing angle within a range where no interference occurs, the conventional technology has room for improvement.

The present disclosure has been made in view of the disadvantage described above, and has an object to provide a technology that can improve the degree of freedom in setting an indexing angle within a range in which interference is avoided, in a case of creating a program for controlling the operation of a machine tool.

### Means for Solving the Problems

The present disclosure relates to a program editing assistance device that assists creation of a program for performing lathe machining on a workpiece by a tool, the program editing assistance device including: an analysis unit that generates, from the program, command data including at least a prescribed position of a prescribed point on a movement path of the tool and a relative indexing angle between the tool and the workpiece at the prescribed position; a tool shape acquisition unit that acquires shape information on one or more components constituting the tool; a range calculation unit that calculates, based on the command data and the shape information, an indexing angle range in which the workpiece and the tool do not interfere with each other at the prescribed position; and a presentation unit that outputs the indexing angle range.

### Effects of the Invention

The present disclosure can provide a technology that can improve the degree of freedom in setting an indexing angle within a range in which interference is avoided, in a case of creating a program for controlling the operation of a machine tool.

### BRIEF DESCRIPTION OF THE DRAWINGS

FIG. 1 is a block diagram showing a configuration of a program editing assistance device according to a first embodiment;

FIG. 2 shows an example of a program command;

FIG. 3 is a table showing a behavior of a tool designated by the program command;

FIG. 4 schematically shows the relationship between the operation of the tool based on the program command, and a workpiece;

FIG. 5 schematically shows one example of components of the tool;

FIG. 6 schematically shows one example of shape information on the tool;

FIG. 7 schematically shows the relationship between a programed path of the tool and the indexing angle;

FIG. 8 shows an example of an indexing angle range presented to an operator in the first embodiment;

FIG. 9 shows an example of the indexing angle range to which a change operation has been applied by the operator in the first embodiment;

FIG. 10 is a flowchart showing an example of the flow of a creation assistance process by the program editing assistance device in the present embodiment;

FIG. 11 shows an example of indexing angle ranges and recommended values presented to the operator in the second embodiment; and

FIG. 12 shows an example of indexing angle ranges to which a change operation has been applied by the operator in the second embodiment.

### PREFERRED MODE FOR CARRYING OUT THE INVENTION

Embodiments of the present disclosure are described below in detail with reference to the drawings. Note that in the description of a second embodiment and later, components common to those in a first embodiment are assigned the same symbols, and their description is omitted as appropriate.

### First Embodiment

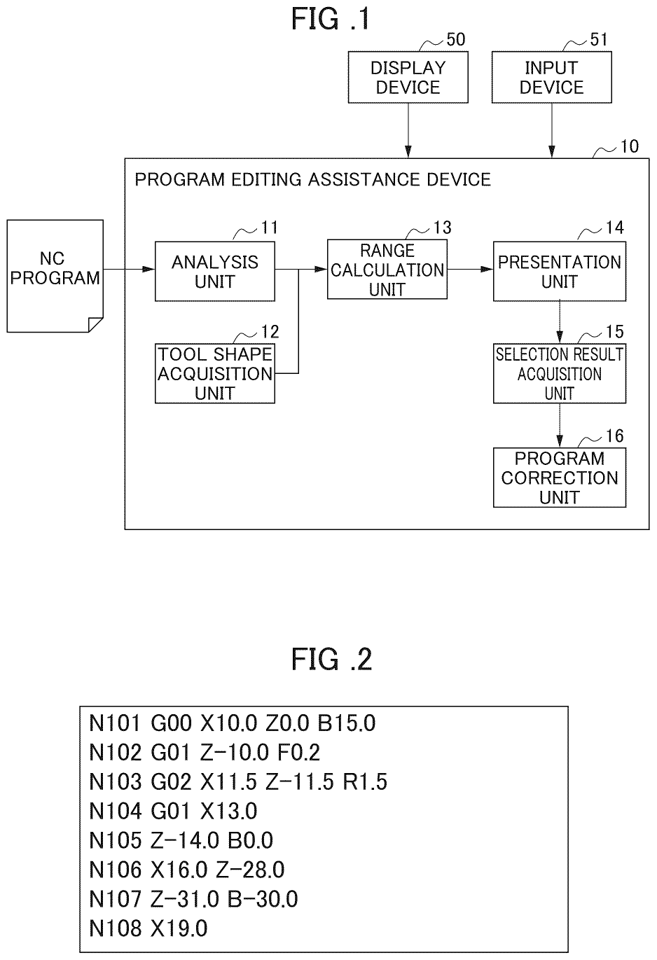

FIG. 1 is a block diagram showing a configuration of a program editing assistance device 10 according to the first embodiment.

The program editing assistance device 10 is an information processing device that assists creation of a program for a machine tool that performs lathe machining on a workpiece using a tool. The machine tool is, for example, a combined lathe that has a mechanism that swivels a tool. The program of the machine tool is, for example, an NC program for performing operation control for the machine tool. In the program, command values and the like for executing machining control, such as the position of a prescribed point (spot) on a movement path of a tool, a movement method and the movement amount of the tool, and the relative indexing angle between the tool and a workpiece, are set. Some of the command values may be parameters preset in the machine tool. The machine tool performs lathe machining on the workpiece, based on the command values of the program, the parameters preset in the machine tool and the like.

The program editing assistance device 10 is configured using, for example, a computer that includes memories, such as a ROM (read only memory) and a RAM (random access memory), a CPU (control processing unit), and a communication control unit that are connected to each other via a bus. The program editing assistance device 10 may be a numerical control device that performs machining control, or a computer that is for creating a program and is independent from a machine tool.

A display device 50 and an input device 51 are connected to the program editing assistance device 10 in the present embodiment. The display device 50 is a display that presents various types of information to an operator through images, sound, or both. The input device 51 is an interface that can receive an input of various settings related to machining and the machine tool, through operations by the operator. The display device 50 and the input device 51 may be independently configured. Alternatively, the display device 50 and the input device 51 may be made up of an integrated touch panel display. As described above, the configurations of the display device 50 and the input device 51 are not specifically limited.

The program editing assistance device 10 includes, as functional units operating in the aforementioned CPU: an analysis unit 11; a tool shape acquisition unit 12; a range calculation unit 13; a presentation unit 14; a selection result acquisition unit 15; and a program correction unit 16. The function and operation of each functional unit of the program editing assistance device 10 are achieved by cooperation of the aforementioned CPU and memories, and a control program stored in the memories. Each functional unit is described.

The analysis unit 11 acquires motion information for analyzing the program, and determining the motion of a tool.

The motion information includes, for example, information for identifying a movement path of a distal end position of the tool. The movement path conforms to the shape of a workpiece. The movement path is described in a manner divided into a plurality of blocks in a program command. Position information, such as a start point indicating an initial position of the tool and an end point indicating a completion position thereof, and a type of movement are set on a block-by-block basis.

The analysis unit 11 in the present embodiment acquires, from the program, motion information that includes a point at a prescribed position in each block on the movement path, and the relative indexing angle of the tool and the workpiece on the point at the prescribed position. The point at the prescribed position in each block is, for example, the aforementioned start point or end point of the block, or an interpolating point indicating the position of the tool between the start point and the end point. The analysis unit 11 generates command data that includes the point at the prescribed position in each block on the movement path, and the relative indexing angle between the tool and the workpiece at the prescribed position, based on the motion information.

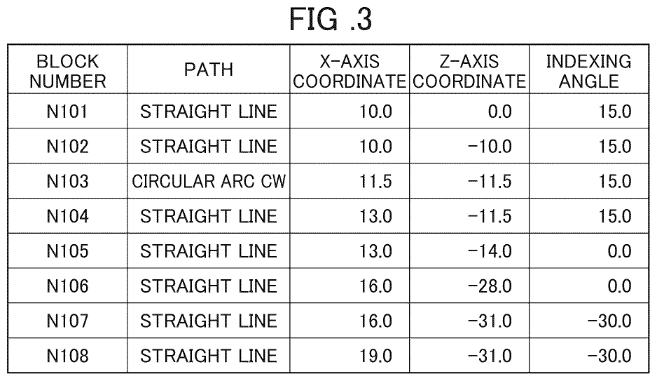

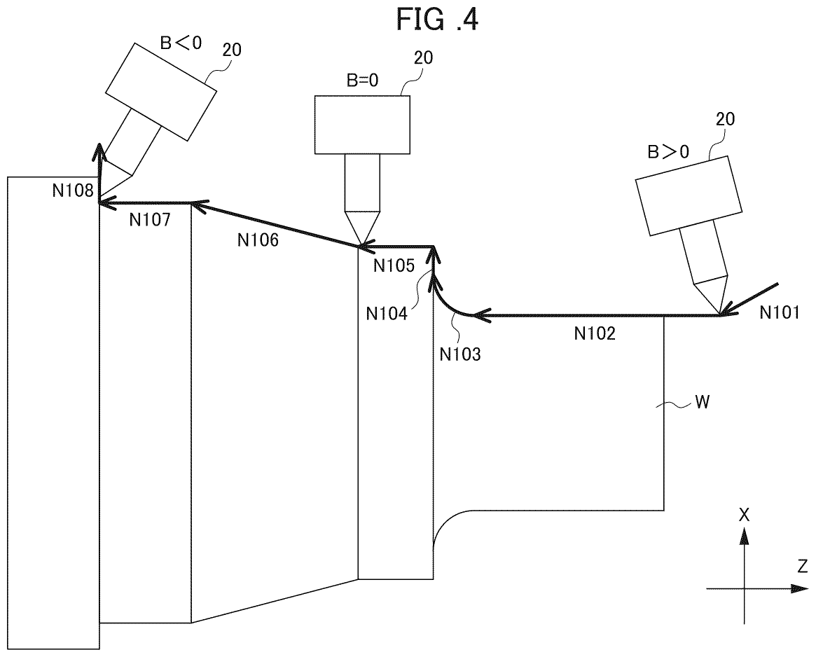

Referring to FIGS. 2 to 4, an analysis example of the analysis unit 11 is described. In the following description, the description is made assuming that the point at a prescribed position of a block is the end point of the block. FIG. 2 shows an example of a program command. FIG. 3 is a table showing a behavior of the tool designated by the program command. FIG. 4 schematically shows the relationship between the operation of a tool 20 based on the program command and a workpiece W. The tool 20 is configured to be rotatable about a B-axis on a ZX plane. The workpiece W is an object that is to be subjected to lathe machining, and rotates about the Z-axis as a rotational axis.

Reference symbols N101 to N108 shown in FIGS. 2 to 4 respectively denote blocks in the program command. Blocks starting with “G00” or “G01” designate linear behaviors and coordinates for positioning, linear interpolation, etc. A block starting with “G02” designates a curved behavior and coordinates, such as of clockwise circular arc interpolation (circular arc CW). In each block, “X” designates an X-coordinate, “Z” designates a Z-coordinate, and “F” designates a feed speed. The distal end position of an edge of the tool 20 is determined by the X-coordinate and the Z-coordinate. “R” designates the radius of circular arc interpolation. “B” denotes an indexing angle designated by the program command.

According to the program in this example, the tool 20 moves with an indexing angle of 15° in N101 to N104, moves with an indexing angle of 0° in N105 and N106, and moves with an indexing angle of −30° in N107 and N108. The analysis unit 11 generates command data that indicates behaviors, such as the position of the edge distal end, indexing angle and the like of the tool 20 shown in FIGS. 3 and 4, from the program in FIG. 2.

The tool shape acquisition unit 12 acquires shape information about the shapes of components constituting the tool on a plane where lathe machining is performed. The components are, for example, a tool rest, a holder, a shank, an edge, etc. The tool shape acquisition unit 12 may acquire the shape information from the command value of the program, or acquire the shape information from a storage unit (not shown) outside of the program editing assistance device 10.

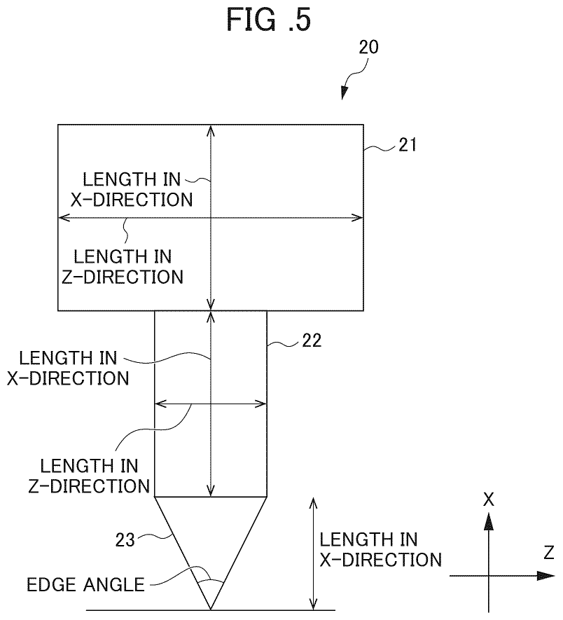

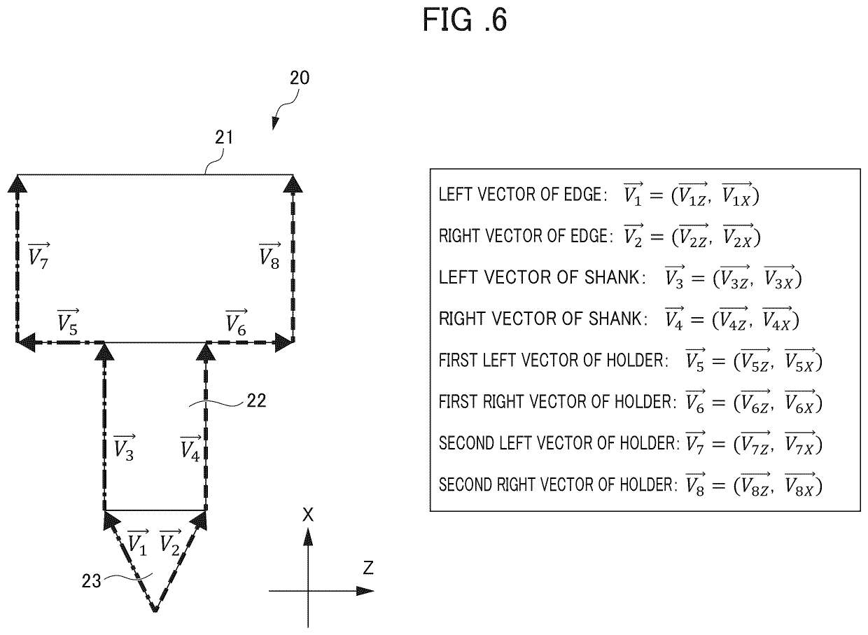

Referring to FIGS. 5 and 6, acquisition of the shape information by the tool shape acquisition unit 12 is described. FIG. 5 schematically shows an example of components of the tool. FIG. 5 shows the components 21 to 23 of the tool 20. The shape information is, for example, information that indicates the shapes of the components 21 to 23 on the ZX plane where cutting machining is performed.

The component 21 is a portion corresponding to a holder (or a tool rest) of the tool 20. The component 22 is a shank portion of the tool 20. The component 23 is an edge portion of the tool 20. In this example, the tool shape acquisition unit 12 acquires the X-axis-direction lengths and the Z-axis-direction lengths of the component 21 and the component 22, and acquires X-axis-direction length and the edge angle of the component 23.

FIG. 6 schematically shows an example of the shape information on the tool 20. As shown in FIG. 6, the tool shape acquisition unit 12 obtains vectors from the edge distal end to the end points of the elements to the left and right, based on the information on the X-axis-direction length, the Z-axis-direction length, and the edge angle of the components 21 to 23.

In FIG. 6, vectors on the left side on the sheet are indicated by chain lines, and vectors on the right side on the sheet are indicated by broken lines. In the example in FIG. 6, the shape information on the component 23 includes a left vector V₁ of the edge, and a right vector V₂ of the edge. The left vector V₁ of the edge is made up of a component V_{1z} in the Z-direction, and a component V₁ₓ in the X-direction. The right vector V₂ of the edge is made up of a component V_{2z} in the Z-direction, and a component V₂ₓ in the X-direction. The shape information on the component 22 includes a left vector V₃ of the shank, and a right vector V₄ of the shank. The left vector V₃ of the shank is made up of a component V_{3z} in the Z-direction, and a component V₃ₓ in the X-direction. The right vector V₄ of the shank is made up of a component V_{3z} in the Z-direction, and a component V₄ₓ in the X-direction. The shape information on the component 21 includes a first left vector V₅ of the holder, a first right vector V₆ of the holder, a second left vector V₇ of the holder, and a second right vector V₈ of the holder. These are also made up of components in the Z-direction and the X-direction. That is, the first left vector V₅ is made up of components V_{5z} and V₅ₓ, the first right vector V₆ is made up of components V_{6z} and V₆ₓ, the second left vector V₇ is made up of components V_{7z} and V₇ₓ, and the second right vector V₈ is made up of components V_{8z} and V₈ₓ. As the shape on the ZX plane is complicated, and the number of sides to be considered increases, the number of vectors in the shape information also increases accordingly.

Note that in this case, the indexing angle B is an angle that indicates the inclination of the tool 20 assuming that a state where the direction of a virtual straight line from the distal end position side (edge side) of the tool 20 toward the proximal end matches a direction orthogonal to the Z-axis direction is regarded as 0 degrees (reference angle). The tool 20 is in an upright state at B=0. The method of inclination is determined depending on the positive or negative sign of B. Which directions the positive and negative directions are set to are freely defined. In this example, inclination from the upright state to the left on the sheet enters a positive region. It is configured such that inclination from the upright state to the right on the sheet enters a negative region.

The range calculation unit 13 acquires the indexing angle of the tool 20 when the tool 20 interferes with the workpiece W, based on an analysis result of the analysis unit 11 and the shape information acquired by the tool shape acquisition unit 12. The shape of the workpiece W can be acquired using the movement path of the tool 20 based on the command value of the program. For example, it is also conceivable that the movement path based on the command value for the edge (distal end) that is the component 23 of the tool 20 is along the surface of the workpiece W that is to be machined.

The indexing angle acquired by the range calculation unit 13 in order to set the indexing angle range is the angle of a position where the tool 20 and the workpiece W interfere with each other at the start point or the end point of the block of the program command. The range calculation unit 13 acquires the indexing angle when the tool 20 and the workpiece W interfere with each other, at the start point or the end point of each block in the program command. The range calculation unit 13 determines the indexing angle range, based on the acquired indexing angle.

In a case where there is another structural object (a chuck, a tail stock, etc.) of the machine besides the workpiece W, the range calculation unit 13 sets the indexing angle range in consideration of interference not only with the workpiece W but also with the other structural object of the machine. For example, the range calculation unit 13 determines whether there is interference between the tool 20 and the other structural object of the machine or not, based on shape information on the other structural object of the machine. The same determination method as the method of detecting interference between the tool 20 and the workpiece W may be used. The indexing angle when interference between the tool 20 and the other structural object of the machine occurs is excluded from the indexing angle range.

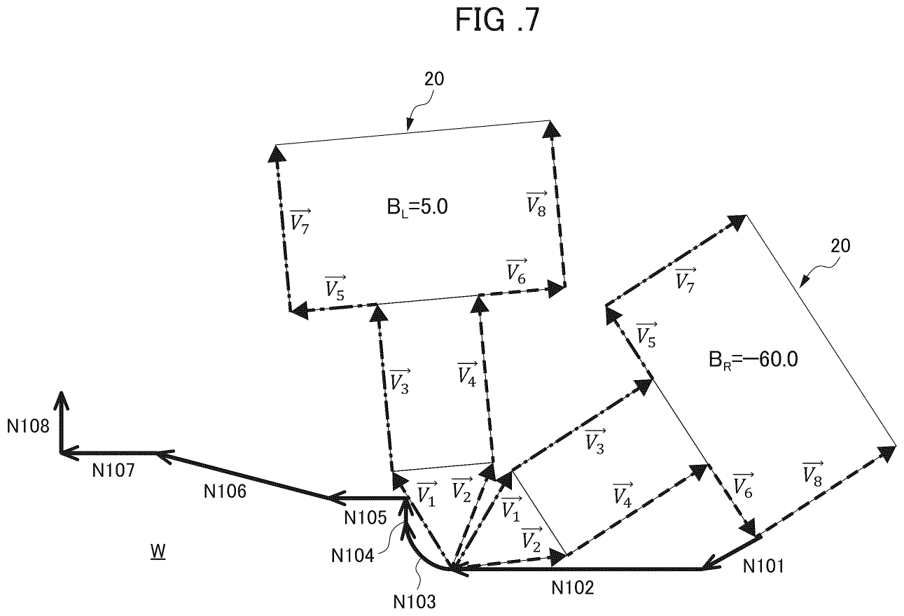

Referring to FIG. 7, as for a calculation example of the indexing angle by the range calculation unit 13, the illustration diagram FIG. 7 is a diagram schematically shows the relationship between the programmed path of the tool 20 and the indexing angle. Each of reference symbols N101 to N108 in FIG. 7 serves as a programmed path (workpiece W) of each block of the command data. As shown in FIG. 7, when the edge distal end that is the component 23 of the tool 20 is at the end point of each block, the range calculation unit 13 obtains the value of an indexing angle BL at which the left-side vector (chain line vector) of the tool 20 is in contact with the programmed path (workpiece W) of the workpiece W. The range calculation unit 13 also obtains an indexing angle BR when the vector indicated by a broken line on the right side of the tool 20 is in contact with the programmed path.

The range calculation unit 13 calculates the indexing angle BL and the indexing angle BR for each block, and acquires the maximum value and the minimum value on a block-by-block basis. In the example in FIG. 7, the angle where the vector indicated by the left-side chain line of the part of the component 23 (edge) at the end point of N102 is in contact with the workpiece W is the indexing angle B_{L}=5.0°, which is the maximum value. On the other hand, the angle where the vector indicated by the right-side broken line of the part of the component 21 (the holder or the tool rest) is in contact with the workpiece W at the end point of N102 is the indexing angle B_{R}=−60°, which is the minimum value. Consequently, the indexing angle range at the end point of the block is from −60° to 5°.

For all the blocks N101 to N108, the range calculation unit 13 calculates the indexing angle BR, which is the minimum value, and the indexing angle BL, which is the maximum value, and acquires the indexing angle range where no interference occurs. Note that in the calculation of the indexing angle range, the left and right of the inclination of the tool 20 from the movement path commanded by the program may be designated by the program, or a setting value preliminarily stored in the program editing assistance device 10, an external computer or the like may be used.

The presentation unit 14 displays the range of the indexing angle calculated by the range calculation unit 13 on the display device 50, thus presenting the range to the operator. The operator is, for example, a user operating the program editing assistance device 10.

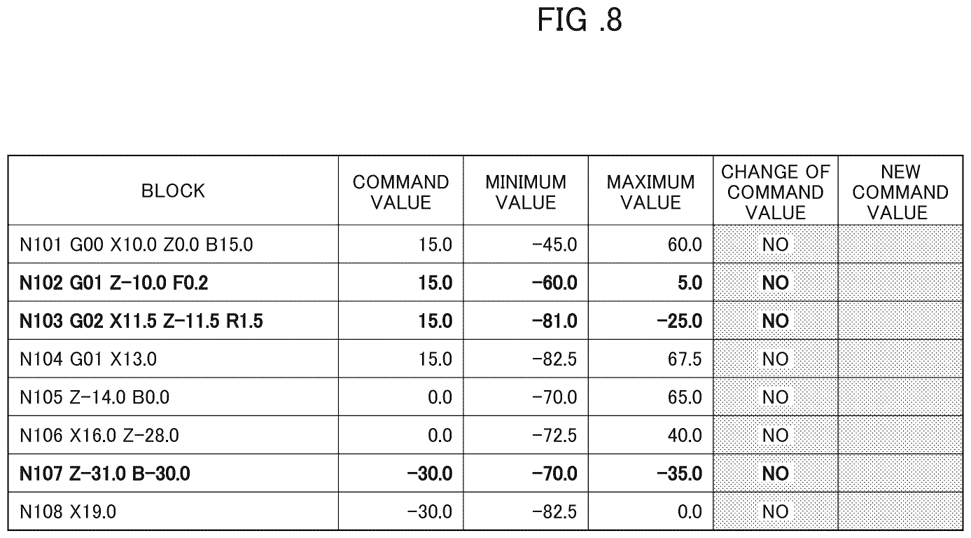

Referring to FIG. 8, the indexing angle range (the minimum value and the maximum value of the indexing angle) presented by the presentation unit 14 is described. FIG. 8 shows an example of the indexing angle range presented to the operator in the first embodiment. FIG. 8 shows, in a table format, information indicating the minimum value and the maximum value of the indexing angle in each of the blocks N101 to N108. In the table in FIG. 8, an item “COMMAND VALUE CHANGED” for checking whether the command value of the program is used as it is or is to be changed is added. In FIG. 8, the stage is for presentation to the operator. Accordingly, in the field “COMMAND VALUE CHANGED” of each of the blocks N101 to N108, “NO” is indicated. “NEW COMMAND VALUE” indicates the indexing angle set by the operator as described later, and is left blank in this stage.

In the example in FIG. 8, when the indexing angle based on the command of the program is out of the indexing angle range designated by the range calculation unit 13, the part concerned is displayed in a mode different from that within the indexing angle range. For the display method in the different mode, for example, change in hue, such as change in color of characters, or change in pattern or shape may be made, or exceedance of the range may be indicated in text. Alternatively, the hue or pattern of the corresponding indicated item may be changed. Further alternatively, temporally changing representation, such as blinking, may be used as a different mode of the display method.

The selection result acquisition unit 15 acquires a selection result indicating whether to use the indexing angle commanded by the program or an indexing angle in the range presented by the presentation unit 14. The selector is, for example, the operator.

The program correction unit 16 executes correction of the program, based on a selection result of the selection result acquisition unit 15.

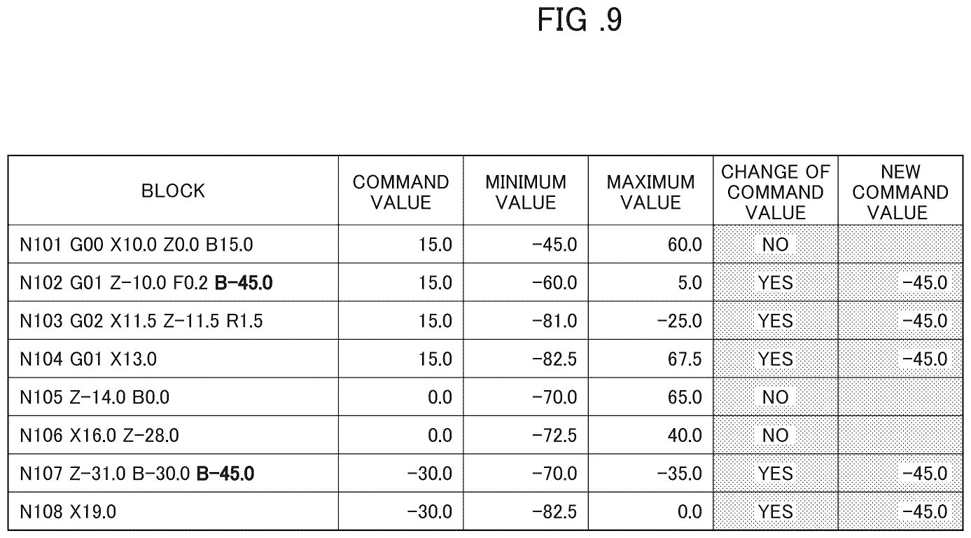

Referring to FIG. 9, an example of acquisition of the operator's selection result by the selection result acquisition unit 15, and correction by the program correction unit 16 is described. FIG. 9 shows an example of the indexing angle range to which a change operation has been applied by the operator in the first embodiment. In the example in FIG. 9, in the field “COMMAND VALUE CHANGED” of each of N102 to N104, N107, and N108 among the blocks N101 to N108, “YES” is set. An indexing angle of −45° input by the operator is input in the field “NEW COMMAND VALUE” of each of N102 to N104, N107, and N108, in which “YES” is set. The operator performs input setting of “COMMAND VALUE CHANGED” or “NEW COMMAND VALUE” through, for example, the input device 51 or an external computer. A configuration may be employed where when the operator performs an operation of inputting and fixing a numerical value in “NEW COMMAND VALUE”, each indication in the “COMMAND VALUE CHANGED” field is automatically changed from NO to YES.

Note that in this example, every indexing angle in the block where “YES” is selected is set to −45°. Alternatively, a different numerical value within the indexing angle range may be input. The selection result acquisition unit 15 acquires, as the operator's selection result, setting of an indexing angle of −45°, which is different from the command value, in N102 to N104, N107, and N108 blocks.

The program correction unit 16 executes correction of the program, based on the selection result acquired by the selection result acquisition unit 15. In the example in FIG. 9, “B−45” indicating the indexing angle is added to N102 block, and the indexing angle of the tool 20 for N102 to N104 becomes −45°. “B−45” is added to N107 that is the block where the indexing angle is changed in the program having not been corrected, and the indexing angle of the tool 20 for N107 and N108 becomes −45°. By the correction process of the program correction unit 16, the indexing angle of the new command value set by the operator is reflected in the program. The correction spot is also reflected in an image displayed on the display device 50, and the state is as in FIG. 9. The correction spot is displayed in a display mode different from that for other parts.

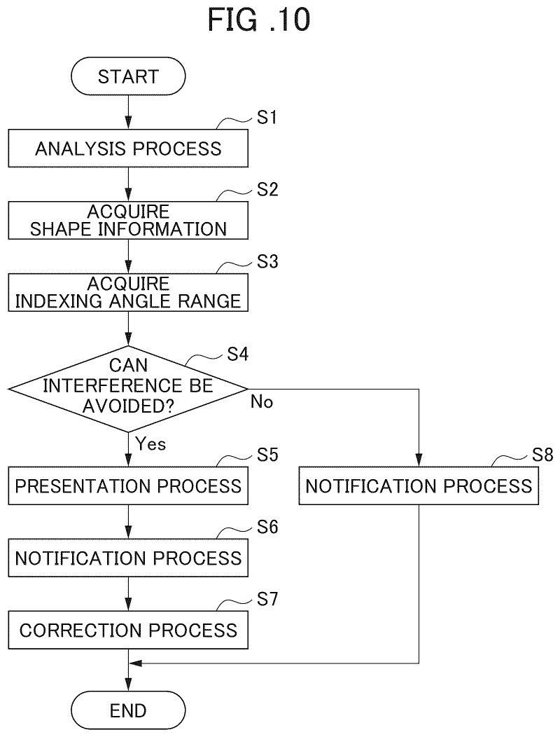

Next, referring to FIG. 10, the flow of the program creation assistance process is described. FIG. 10 is a flowchart showing an example of the flow of a creation assistance process by the program editing assistance device 10 in the present embodiment. The flowchart shown in FIG. 10 is only an example. The order and content of the processes can be changed as appropriate.

In Step S1, the analysis unit 11 analyzes the program, generates command data, and transmits the data to the range calculation unit 13.

Next, in Step S2, the tool shape acquisition unit 12 acquires shape information on a plane where lathe machining is performed, and transmits the information to the range calculation unit 13.

Next, in Step S3, the range calculation unit 13 executes the aforementioned process for setting the indexing angle range in each block, based on the analysis result (command data) of the analysis unit 11 and the shape information acquired by the tool shape acquisition unit 12.

Next, in Step S4, the range calculation unit 13 determines whether the indexing angle range that avoids interference can be set or not. When the range calculation unit 13 cannot set the indexing angle range that avoids interference, the processing transitions to Step S8 (Step S4; No). In Step S8, the presentation unit 14 executes a process of outputting occurrence of interference and incapability of setting the indexing range angle, to the display device 50.

When the range calculation unit 13 can set the indexing angle range that avoids interference, the processing transitions to Step S5 (Step S4; Yes). In Step S5, the presentation unit 14 transmits image information to the display device 50 in order to present the indexing angle range in each block of the program command to the operator.

In Step S6, the selection result acquisition unit 15 acquires the selection result of the operator who has checked the information presented by the presentation unit 14. The selection result described here is information based on an input operation by the operator.

In Step S7, the program correction unit 16 corrects the program command, based on the selection result acquired by the selection result acquisition unit 15. The program correction unit 16 causes the presentation unit 14 to execute a process of reflecting a correction result in information to be displayed on the display device 50.

According to the program editing assistance device 10 in the present embodiment described above, the following advantageous effects are exerted. The program editing assistance device 10 includes: the analysis unit 11 that generates command data that at least includes the prescribed position of the prescribed point on the movement path of the tool 20, and the relative indexing angle between the tool 20 and the workpiece W at the prescribed position, based on the program; the tool shape acquisition unit 12 that acquires shape information on one or more components included in the tool 20; the range calculation unit 13 that calculates the indexing angle range in which the workpiece W and the tool 20 do not interfere with each other at the prescribed position, based on the command data and the shape information; and the presentation unit 14 that outputs the indexing angle range.

Accordingly, the operator can easily grasp the indexing angle range where no interference occurs. Even in a case where a program is manually created, the operator can easily designate an appropriate indexing angle, based on the grasped indexing angle range.

In the present embodiment, the components 21 to 23 are at least one or more among the tool rest that stores the tool 20, the holder, and the shank and the edge of the tool 20.

Accordingly, in consideration of the shape of the tool 20 actually used for cutting machining, the indexing angle range can be more appropriately presented to the operator.

In the present embodiment, the range calculation unit 13 sets the maximum value and the minimum value of the indexing angle range when the tool 20 is in contact with the movement path at the prescribed position.

Accordingly, using the maximum value and the minimum value, the indexing angle range can be clearly presented to the operator.

In the present embodiment, the range calculation unit 13 reflects, in the indexing angle range, interference with a structural object of a machine that performs the lathe machining.

Accordingly, the indexing angle range that can avoid interference with the structural object of the machine can be set, and the indexing angle can be set in this indexing angle range.

In the present embodiment, when it is determined that interference between the tool 20 and the workpiece W cannot be avoided even by changing the indexing angle, the range calculation unit 13 notifies that interference cannot be avoided.

Accordingly, the operator can easily and quickly grasp a situation where interference cannot be avoided even if the indexing angle is changed.

The program editing assistance device 10 in the present embodiment further includes: a selection result acquisition unit 15 that acquires a selection result indicating that the operator has selected either the indexing angle designated by the program or an indexing angle within the indexing angle range; and a program correction unit 16 that corrects the program, based on the selection result.

Accordingly, when the operator selects the indexing angle in the indexing angle range, the program is automatically corrected, and cutting machining is performed by a command based on the indexing angle that securely prevents interference.

In the present embodiment, the presentation unit 14 displays information indicating that the indexing angle commanded by the program is within the indexing angle range, and information indicating that the indexing angle commanded by the program is out of the indexing angle range, respectively in different display modes in a distinct manner.

Accordingly, the operator can easily grasp whether the indexing angle in the command of the program may possibly cause interference or not, based on the different display modes.

### Second Embodiment

Although the example of the program editing assistance device 10 in the first embodiment has been described above, the configuration is not limited to this configuration. Next, a program editing assistance device 10 in a second embodiment is described.

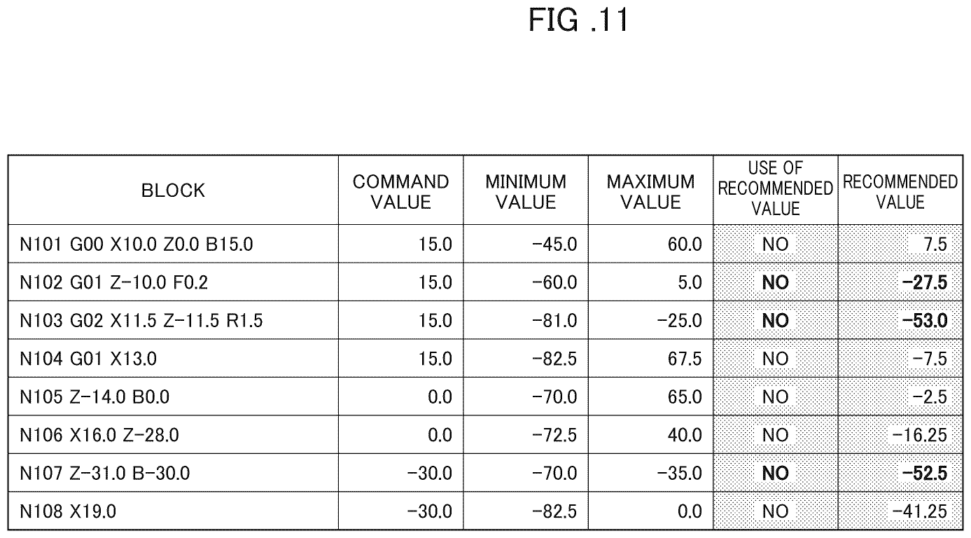

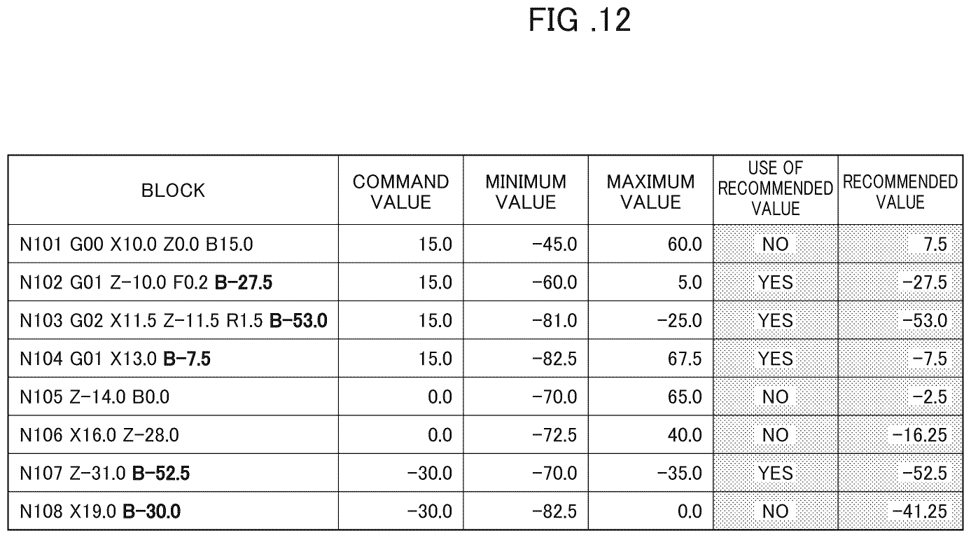

The program editing assistance device 10 in the second embodiment includes components common to those in the first embodiment. The second embodiment is different in information presented by the presentation unit 14, a format of input by the operator, and the like. Referring to FIGS. 11 and 12, a process of displaying a recommended value by the presentation unit 14 is described.

FIG. 11 shows an example of an indexing angle range and recommended values presented to the operator in the second embodiment. In the example in FIG. 11, “COMMAND VALUE CHANGED” in FIGS. 8 and 9 in the first embodiment is changed to “USE OF RECOMMENDED VALUE”, and the item “NEW COMMAND VALUE” is changed to “RECOMMENDED VALUE”.

The presentation unit 14 in the second embodiment displays one or more indexing angles in the calculated range, as recommended values, together with the indexing angle range, on the display device 50, thus presenting them to the operator.

A process of calculating the recommended value is described. The presentation unit 14 acquires, as a recommended value, a representative value of the indexing angle range acquired by the range calculation unit 13. The representative value may be, for example, the median value or the average value of the indexing angle range for the block.

Alternatively, the maximum value or the minimum value of the indexing angle range may be used as it is.

In the example in FIG. 11, the presentation unit 14 presents the median value of the indexing angle range, as the recommended value, to the operator. The recommended values are calculated for all the N101 to N108 blocks.

Also in the second embodiment, the presentation unit 14 executes a process of displaying blocks with the indexing angles calculated based on the command value being out of the indexing angle range, in the display mode in a manner distinct from that for blocks with the indexing angles within the indexing angle range. In this example, the presentation unit 14 displays, on the display device 50, “NO” of the “USE OF RECOMMENDED VALUE” field and the recommended values in each block, with their color being changed.

FIG. 12 shows an example of the indexing angle range to which a change operation has been applied by the operator in the second embodiment. In the example in FIG. 12, “USE OF RECOMMENDED VALUE” for each of N102 to N104, and N107 blocks has been changed to YES by the operator. For each of N102 to N104, and N107 blocks where YES is set, the selection result acquisition unit 15 acquires, as the operator's selection result, setting of a recommended value instead of the command value.

Here, a case is described where the command value of the indexing angle is changed to the recommended value for a certain block, and “NO” is set in the “USE OF RECOMMENDED VALUE” field for each of the following blocks. Typically, when an indexing angle is set in a certain block, the indexing angle set in this block is applied, as it is, to each of the following blocks until an indexing angle is newly set. The program correction unit 16 in the present embodiment recognizes that for the blocks where NO is set, no change by the operator is intended, and newly sets the indexing angle to be applied to an unchanged program instead of the recommended value. More specifically, the program correction unit 16 sets the indexing angle to the recommended value for N107 where “YES” is set, and sets the indexing angle to that applied in a case of execution in the unchanged program, for N108 where “NO” is set, instead of application of the recommended value for N107. In the example in FIG. 12, “B−30.0” is added to the N108 block. These correction spots are also displayed in a display mode different from that for other parts.

As described above, in the second embodiment, besides the advantageous effects exerted by the first embodiment, the following advantageous effects are exerted.

The presentation unit 14 in the second embodiment presents, in addition to the indexing angle range, one or more indexing angles within the indexing angle range, as recommended values.

Accordingly, even though the operator makes no designation by themself, the indexing angle within the indexing angle range that causes no interference can be easily set using the recommended value.

In the second embodiment, the presentation unit 14 presents any of the median value, the maximum value, the minimum value, or the average value of the indexing angle range, as the recommended value.

Accordingly, the recommended value can be easily and securely calculated by a simple process.

While the present disclosure has thus been described in detail, the present disclosure is not limited to the aforementioned individual embodiments. These embodiments can undergo addition of various components, or be replaced, changed, or partially removed, in a range without deviating from the gist of the present disclosure, or in a range without deviating from the spirit of the present disclosure derived from the content described in the claims and their equivalents. These embodiments may be implemented in a combined manner. For example, in the embodiments described above, the order of the operations, and the orders of the processes are described as examples. There is no limitation to them. This also applies in cases where numerical values and mathematical expressions are used for the description of the aforementioned embodiments.

The following further discloses additional remarks regarding the foregoing embodiment and modification examples thereof.

### (Additional Remark 1)

A program editing assistance device that assists creation of a program for performing lathe machining on a workpiece (W) by a tool (20), the program editing assistance device including: an analysis unit (11) that generates, from the program, command data including at least a prescribed position of a prescribed point on a movement path of the tool (20) and a relative indexing angle between the tool (20) and the workpiece (W) at the prescribed position;
a tool shape acquisition unit (12) that acquires shape information on one or more components (21) to (23) constituting the tool (20);
a range calculation unit (13) that calculates, based on the command data and the shape information, an indexing angle range in which the workpiece (W) and the tool (20) do not interfere with each other at the prescribed position; and a presentation unit (14) that outputs the indexing angle range.

### (Additional Remark 2)

In the program editing assistance device (10) described above,
the presentation unit (14) presents, in addition to the indexing angle range, one or more indexing angles within the indexing angle range as a recommended value.

### (Additional Remark 3)

In the program editing assistance device (10) described above,
the presentation unit (14) presents any of a median value, a maximum value, a minimum value, or an average value of the indexing angle range as the recommended value.

### (Additional Remark 4)

In the program editing assistance device (10) described above,
the components include at least one selected from a tool rest that stores the tool (20), a holder, a shank of the tool (20), and an edge of the tool (20).

### (Additional Remark 5)

In the program editing assistance device (10) described above,
the range calculation unit (13) sets a maximum value and a minimum value of the indexing angle range when the tool (20) comes into contact with the movement path at the prescribed position.

### (Additional Remark 6)

In the program editing assistance device (10) described above,
the range calculation unit (13) reflects, in the indexing angle range, interference with a structural object of a machine that performs the lathe machining.

### (Additional Remark 7)

In the program editing assistance device (10) described above,
in a case where it is determined that interference between the tool (20) and the workpiece (W) cannot be avoided even with change of the indexing angle, the range calculation unit (13) notifies that the interference cannot be avoided.

### (Additional Remark 8)

The program editing assistance device (10) described above, further including:
a selection result acquisition unit (15) that acquires a selection result indicating selection of the indexing angle designated by the program or an indexing angle within the indexing angle range by an operator; and
a program correction unit (16) that corrects the program based on the selection result.
   (Additional Remark 9) In the program editing assistance device (10) described above,

The Presentation Unit (14) Displays:
information indicating that the indexing angle commanded by the program is within the indexing angle range; and
information indicating that the indexing angle commanded by the program is out of the indexing angle range, in different display modes in a distinct manner.

### EXPLANATION OF REFERENCE NUMERALS

10 program editing assistance device
11 analysis unit
12 tool shape acquisition unit
13 range calculation unit
14 presentation unit
15 selection result acquisition unit
16 program correction unit
20 tool
21 to 23 component

1. A program editing assistance device that assists creation of a program for performing lathe machining on a workpiece by a tool, the program editing assistance device comprising:
an analysis unit that generates, from the program, command data including at least a prescribed position of a prescribed point on a movement path of the tool and a relative indexing angle between the tool and the workpiece at the prescribed position;
a tool shape acquisition unit that acquires shape information on one or more components constituting the tool;
a range calculation unit that calculates, based on the command data and the shape information, an indexing angle range in which the workpiece and the tool do not interfere with each other at the prescribed position; and
a presentation unit that outputs the indexing angle range.

2. The program editing assistance device according to claim 1, wherein the presentation unit presents, in addition to the indexing angle range, one or more indexing angles within the indexing angle range as a recommended value.

3. The program editing assistance device according to claim 2, wherein the presentation unit presents any of a median value, a maximum value, a minimum value, or an average value of the indexing angle range as the recommended value.

4. The program editing assistance device according to claim 1, wherein the components comprise at least one selected from a tool rest that stores the tool, a holder, a shank of the tool, and an edge of the tool.

5. The program editing assistance device according to claim 1, wherein
the range calculation unit sets a maximum value and a minimum value of the indexing angle range when the tool comes into contact with the movement path at the prescribed position.

6. The program editing assistance device according to claim 1, wherein
the range calculation unit reflects, in the indexing angle range, interference with a structural object of a machine that performs the lathe machining.

7. The program editing assistance device according to claim 1, wherein
in a case where it is determined that interference between the tool and the workpiece cannot be avoided even with change of the indexing angle, the range calculation unit notifies that the interference cannot be avoided.

8. The program editing assistance device according to claim 1, further comprising:
a selection result acquisition unit that acquires a selection result indicating selection of the indexing angle designated by the program or an indexing angle within the indexing angle range by an operator; and
a program correction unit that corrects the program based on the selection result.

9. The program editing assistance device according to claim 1, wherein
the presentation unit displays:
information indicating that the indexing angle commanded by the program is within the indexing angle range; and
information indicating that the indexing angle commanded by the program is out of the indexing angle range,
in different display modes in a distinct manner.
